(19) United States
(12) Patent Application Publication
(10) Pub. No.: US 2025/0186910 A1
(43) Pub. Date: Jun. 12, 2025

(54) A SELF-CLEANING FILTER FOR LIQUIDS

(71) Applicant: FILTERECO S.R.L., OLGINATE (LC) (IT)

(72) Inventor: Luca GRECO, Abbadia Lariana (LC) (IT)

(21) Appl. No.: 18/843,920

(22) PCT Filed: Mar. 3, 2023
(86) PCT No.: PCT/IB2023/052001

§ 371 Date: Sep. 4, 2024

(30) Foreign Application Priority Data
Mar. 4, 2022 (IT) 102022000004109

(51) Int. Cl. B01D 29/075; B01D 29/03; B01D 29/64; B01D 29/94

(52) U.S. Cl. CPC B01D 29/075; B01D 29/036; B01D 29/6476; B01D 29/94; B01D 2201/34

(57) ABSTRACT

The invention relates to a self-cleaning filter (1) for liquids comprising a body (10) that includes a first chamber (20), with an inlet (14) for a liquid to be filtered, and a second chamber (30), with a liquid outlet (33), wherein the two chambers are substantially superimposed and communicating by means of a flat filter medium (40), wherein the first chamber (20) is in communication with a discharge passage (26) for elimination of unwanted material, said discharge passage being closed by a closing element (50) mounted rotatably in the first chamber (20), and wherein at least one scraper element (60) is connected to the closing element (50) and is in contact with the filter medium (40) so that, following rotation, said scraper element (60) can remove any accumulation of unwanted material that has deposited on the filter medium (40) and convey it toward the discharge passage (26).

The present invention relates to a self-cleaning filter for liquids, more in detail to a self-cleaning filter of the type provided with a scraper.

The invention relates to the field of liquid filtration in industry, in particular to filtration systems of industrial equipment and plants using process liquids that must be filtered, for example to separate solid particles or other unwanted residual materials, before being returned to the production cycle or collected to be used for other purposes or to be disposed of.

However, for some applications the filter device of the present invention can also be used as a separator device to separate two liquid substances, for example, it can be used as oil separator, while also maintaining its filtering capacity.

Various types of so-called self-cleaning filters are known on the market, i.e., configured to periodically, and generally automatically, carry out a process to clean and restore the filtering surface without requiring its replacement and/or action by an operator.

Among the types of known self-cleaning filters used in industry to filter liquids, such as water, oils, glues or other chemical substances, etc., those most widely used are backwash or scraper filters.

However, filters of the aforesaid type present on the market have some limits and disadvantages.

A first limit that affects both backwash filters and scraper filters is the fact that a moderate amount of liquid, generally considerably higher than the amount of residues, is eliminated together with the unwanted residues to be separated/eliminated.

Often, these residues must by dried or, in any case, separated from a substantial fraction of excess liquid before being accumulated for disposal or for other uses. At times this liquid has a considerable economic value, hence making it advantageous to recover the fraction eliminated from the self-cleaning filter, especially in medium-sized and large plants, in which the body of the filter can have a volume of even a few tens of litres.

For these reasons, many filtering plants equipped with self-cleaning filters of known type are also equipped with further filtration devices, such as filter bags or similar, placed downstream of the discharge outlet of the self-cleaning filter.

In other systems the discharge of the self-cleaning filter is conveyed into tanks or drums, where the residues are separated from the liquid fraction by decantation.

Besides increasing the footprint and the costs of the plant, these filtration/separations devices require maintenance operations, such as replacement of the filtering element or of the collection tank, operations which, although not particularly frequent, must be carried out manually by an operator.

Moreover, in both cases mentioned, in order to return the separated liquid to the plant further pipes and valves are generally used, thereby complicating the plant and increasing costs.

In this context, the object of the present invention is to propose a self-cleaning filter that overcomes the aforesaid limits of the prior art.

In detail, an object of the present invention is to produce a self-cleaning filter capable of eliminating the filtration residues dried or, in any case, with a negligible liquid fraction.

Another object of the present invention is to provide a self-cleaning filter that is of simple construction and is inexpensive to produce.

A further object of the present invention is to produce a self-cleaning filter with a limited footprint.

Yet another object of the present invention is to produce a self-cleaning filter that can be used in a filtration plant as main filter or as further filter for drying the residues eliminated from self-cleaning filters of the prior art.

One more object of the present invention is to provide a self-cleaning filter that can also perform a function of separator for two liquid substances.

These and other objects are achieved by a self-cleaning filter in conformity with the appended claim 1.

In detail, according to the present invention, the self-cleaning filter comprises a body provided with a first chamber communicating with an inlet for the inflow of a liquid to be filtered. According to a variant of the invention, the body preferably also comprises a second chamber communicating with a liquid outlet. The two first and second chambers are substantially superimposed and communicating with each other by means of a flat filter medium. Each chamber preferably comprises at least one side wall, one base wall and one upper wall. The body is preferably open at the upper wall of the first chamber. According to this variant, the first chamber, and more generally the inner volume of the body, is closed by a removable upper cover.

Hereinafter, the terms above, below, upper, lower, superimposed, etc. refer to the position of normal use of the filter in which the first chamber is above the second chamber and they are substantially aligned with each other along a vertical direction.

The liquid inlet into the first chamber is preferably produced in the cover. The liquid outlet from the second chamber is preferably produced in the side wall thereof.

The first chamber is also in communication with a discharge passage, communicating with the outside, that allows the elimination of unwanted materials separated and retained by the filter medium. For this purpose, a closing element of the discharge passage is also housed in the first chamber. Said closing element is mounted so as to be able to rotate in the first chamber around a circular trajectory that comprises a cleaning path and a closing position of the discharge passage.

According to a variant of the invention, this rotation is controlled by an electric motor connected to the closing element.

According to another variant of the invention, rotation of the closing element is controlled by a pneumatic actuator assembly.

According to the invention, said closing element is connected to at least one scraper element adapted to remain in contact with the filter medium during the movement of the closing element in the section of the cleaning path.

When the filter is in operating condition, i.e. when it must filter liquid flowing into the first chamber, the closing element is in the closing position so as to obstruct the discharge passage. The liquid from the first chamber can then flow into the second chamber through the filter medium which separates the unwanted material from the liquid and retains it in the first chamber.

When the accumulation of unwanted material on the filter medium reaches a limit threshold, for example when the flow rate or the pressure of the liquid flowing out of the second chamber drops below a given threshold, it is possible to activate, manually or automatically, a cleaning cycle of the filter medium.

Said cleaning cycle entails interruption of the flow of liquid upstream of the filter and subsequent rotation of the closing element so that the scraper element can remove the accumulation of unwanted material deposited on the filter medium and convey it toward the discharge passage through which it is eliminated from the filter.

The closing element can carry out one or more rotations along the cleaning path, i.e., it can travel along said section once or more than once, in a single direction of rotation or in opposite directions of rotation.

Once the cleaning cycle has been completed, the closing element is returned to the closing position and the flow rate of liquid flowing into the filter can be restored.

Thanks to the arrangement of the two first and second superimposed chambers and to the presence of the flat filter medium that divides them, the filter according to the present invention can function both with a flow of liquid at the inlet “falling by gravity”, i.e., with very limited pressures, and with pumping means located upstream of the inlet of the first chamber or downstream of the outlet of the second chamber, i.e. operating with suction.

Moreover, thanks to the aforesaid structure, when the flow of liquid at the inlet is interrupted, the liquid present in the first chamber, and any liquid in the pipes upstream, can fall by gravity through the filter medium into the second chamber.

In this way, when the cleaning cycle is activated, the unwanted material eliminated through the discharge passage either has no liquid or only contains an irrelevant fraction of liquid.

If necessary, before the cleaning cycle, air can be insufflated into the first chamber to facilitate drying of the unwanted material.

Unlike prior art filters, with the self-cleaning filter of the present invention it is thus possible to separate and eliminate unwanted material without wasting liquid and without requiring further filtering and separating devices downstream.

Advantageously, the self-cleaning filter of the present invention can also be used as secondary filter, downstream of a self-cleaning filter of known type, to separate and recover the part of liquid eliminated from the main self-cleaning filter automatically without requiring manual operations as occurs in systems currently in use.

According to a possible simplified variant of the invention, the body can comprise only the first upper chamber and the filtered liquid can be discharged directly from the filtering element falling by gravity.

This variant of the filter can be advantageous when the filter operates with unpressurized liquids, for example when the filtered liquid is collected in a tank or drum. In fact, in this case it is sufficient to suitably convey the flow of the liquid falling by gravity from the filtering element and the unwanted material eliminated from the discharge passage.

According to an aspect of the invention, the first chamber has a substantially cylindrical and preferably flattened shape, i.e., the diameter of the inner surface is greater than the height. Preferably, the value of the outer diameter is at least double that of the height, more preferably at least triple. According to a preferred variant, the value of the diameter is around ten times the value of the height.

The filter medium and the discharge passage are arranged at the base, or lower, surface of the first chamber.

More in detail, according to a preferred embodiment, said filter medium has a plan profile in the shape of a circular sector or circular ring sector. The discharge passage preferably also has a circular sector or circular ring sector plan shape substantially complementary to that of the filter medium.

The second chamber, where present, preferably has a plan shape substantially corresponding to that of the filter medium.

The second chamber also has a flattened shape. The outer circumference of the second chamber has a diameter at least twice, preferably three times, the height. According to a preferred variant, the value of the diameter is around ten times that of the height.

Thanks to this configuration, the body has a limited height, or depth, with respect to the filtering surface.

This flattened shape allows a reduction in the volume of the liquid to be eliminated and optimization of the footprint of the filter, in particular with respect to the filtering and separating systems positioned downstream of prior art self-cleaning filters.

According to another aspect of the invention, the filter medium generally comprises filtering mesh, perforated metal sheets, filtering elements of wedge wire screen type, or other filtering elements compatible with the flat arrangement.

In the variant in which the filter is used as liquid separator, for example as oil separator, the filtering element can comprise one or more layers of fabric, for example fabrics made of nylon fibres treated with nanoparticles.

According to another aspect of the invention, the closing element comprises a support element mounted on the body in a manner rotatable about a substantially vertical axis Y. Said support element can be pivoted on the base wall of the first chamber or, preferably, on the cover. If necessary, the support element can be hinged to both said parts.

A shaft extends from the support and, according to a variant of the invention, is connected to a gear motor that controls the rotation of the closing element.

According to another variant, the shaft of the support element is connected to a pneumatic actuator assembly comprising a ratchet lever, mounted on the shaft, which is in turn connected to the end of a rod of a pneumatic cylinder. At each cycle of extension and retraction of the rod, the support element, and hence the closing element, carry out a partial rotation.

According to this variant, the pneumatic actuator assembly comprises a rotation control device configured to constrain the support element to a rotation of a predetermined and constant angle at each extension and retraction cycle of the piston. In this way, correct positioning of the closing element with respect to the discharge passage is guaranteed at all times, in the operating condition of the filter.

A sealing element is connected to said support element and, in the closing position, it is adapted to rest on the base wall of the first chamber at an edge that delimits the discharge passage. The sealing element is made of a material that guarantees the fluid-tight seal of the discharge passage and, if necessary, also good sliding during rubbing in contact with the edge that delimits the discharge passage. Examples of suitable materials are polytetrafluoroethylene (PTFE), glass fiber reinforced polymers, graphene, other composite polymers, soft metals such as bronze or aluminium, or elastomers.

According to an aspect of the invention, the sealing element is mounted on the support element with slight clearance along a vertical direction and is subject to the action of elastic means that press the sealing element against the base wall of the first chamber. Said elastic means thus promote the hydraulic seal when the sealing element is at the discharge passage in the closing position.

According to an aspect of the invention, the sealing element comprises a flat plate with a circular sector, or substantially triangular, plan shape having a surface slightly larger than the area of the discharge passage.

According to another variant of the invention, the filter can comprise a pneumatic actuator that acts as presser to maintain the sealing element pressed against the base wall of the first chamber when the filter is in operating condition, to improve the hydraulic seal when the filter operates under pressure (e.g. over 5 bar).

Said actuator comprises a cylinder arranged vertically, the rod of which is housed sliding inside the cover, with its end extending into the first chamber.

The rod can rest directly on the closing element or, preferably, is connected to a pad which is in turn carried into contact against the sealing element.

This variant of the invention is particularly advantageous when the filter is used to separate permeable solids, such as cellulose, chalk, sludges, etc. which, once dried or highly dewatered, tend to form a compact block.

In these cases, as discharge of these substances by falling by gravity into the discharge passage would be difficult or, at times, impossible, the material to be discharged can be forced into the discharge passage by pressing it downward with the pad fixed to the presser actuator.

Rotating the support element by predefined angular steps it is possible to gradually push all the material deposited on the filter medium inside the discharge passage.

According to a preferred embodiment, the edge that delimits the discharge passage into the first chamber is slightly raised with respect to the surface of the filtering element. In this way, the sealing element can be mounted on the support element so as not to rub on the surface of the filtering element during rotation of the closing element, avoiding excessive wear of both parts.

Instead, in the closing position, the raised edge of the discharge passage ensures that the sealing element is pushed upward stressing the elastic means and increasing the hydraulic seal.

The at least one scraper element is also mounted on the support element and comprises a bar arranged radially with respect to the rotation axis Y of the closing element, or slightly tangential.

According to an aspect of the invention, said scraper element is mounted on the support element with slight clearance in a vertical direction and is subject to the action of elastic means that press it against the filter medium to facilitate the scraping action along the cleaning path.

The scraper element is preferably arranged adjacent to the sealing element, i.e., at the side of one of the (radii) of the circular sector.

According to a variant, two scraper elements are mounted on the support element, preferably each arranged adjacent to one of the sides of the sealing element.

According to another aspect of the invention, the closing element, and specifically the support element, is connected to and is integral in rotation with disintegrating elements of the layer of unwanted material accumulated on the filter medium. Said disintegrating elements, during rotation of the closing element in the cleaning cycle, help to disintegrate said layer of material, which may be compacted, facilitating the removal action of the scraper element.

According to an embodiment of the invention, said disintegrating elements comprise one or more arms extending in radial direction from the support element, each of which carries a plurality of prongs projecting downward and which extend almost to the base wall of the first chamber.

Preferably, to make the assembly formed by the support element and the arms stiffer, an annular perimeter element is fixed to the ends of said arms.

Preferably said parts, the support element, the arms and the annular element, are produced in one piece, typically made of metal.

Other features and advantages of the invention will be apparent from the detailed description below of non-limiting embodiments of the invention, with reference to the accompanying figures, wherein:

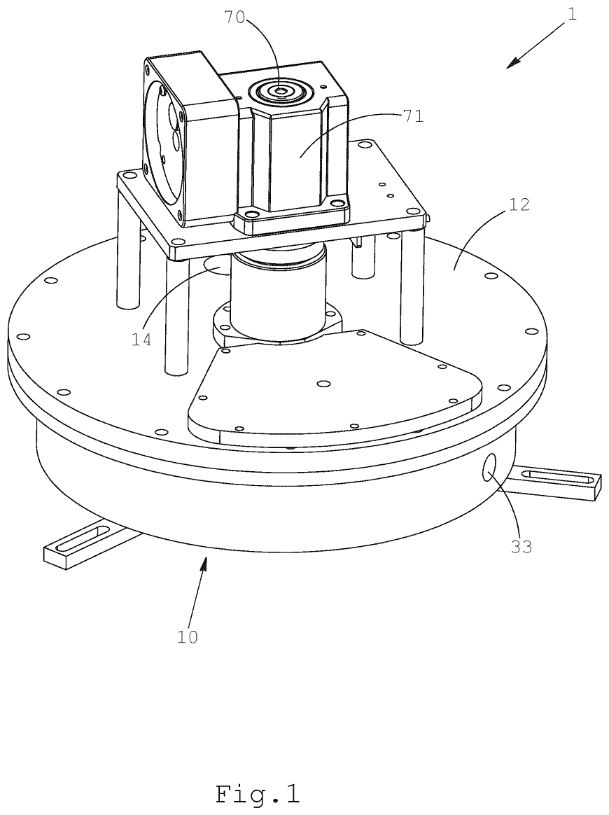

FIG. 1 represents a perspective view of a self-cleaning filter according to an embodiment of the present invention;

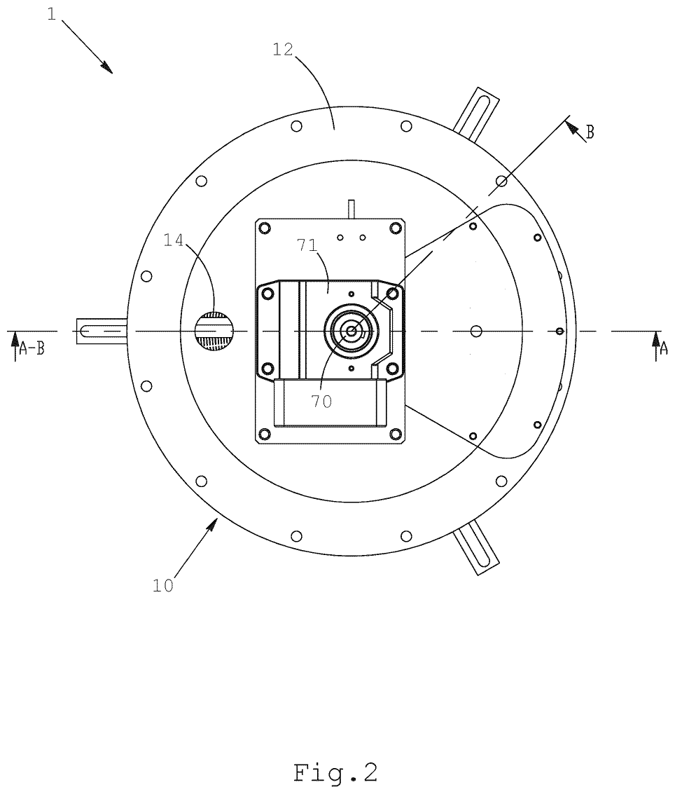

FIG. 2 is a plan view of the self-cleaning filter of FIG. 1;

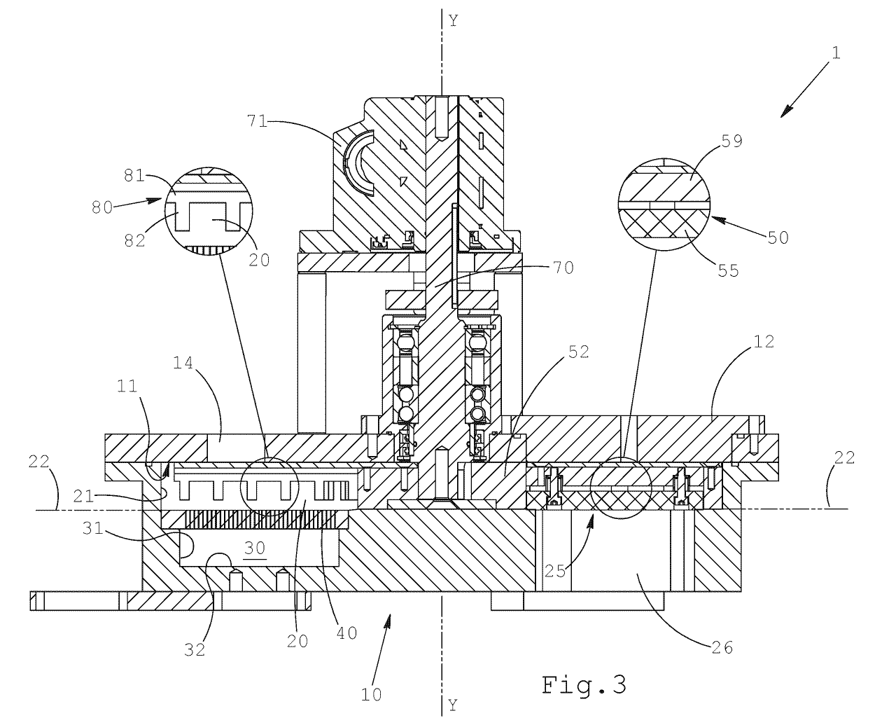

FIG. 3 is a side view of the self-cleaning filter of FIG. 1 sectioned along a vertical median plane A-A;

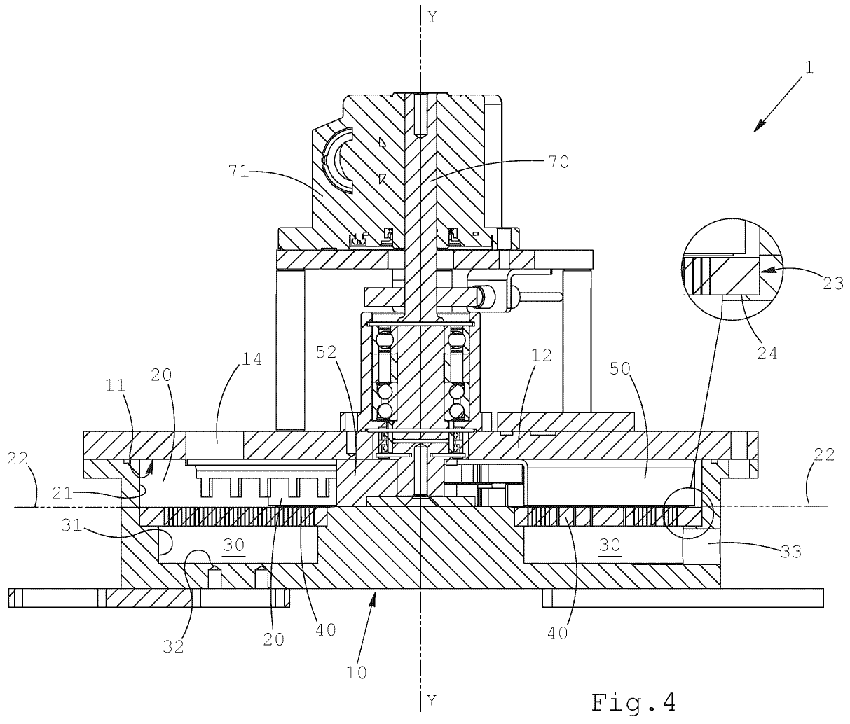

FIG. 4 is a side view of the self-cleaning filter of FIG. 1 sectioned along a vertical plane B-B;

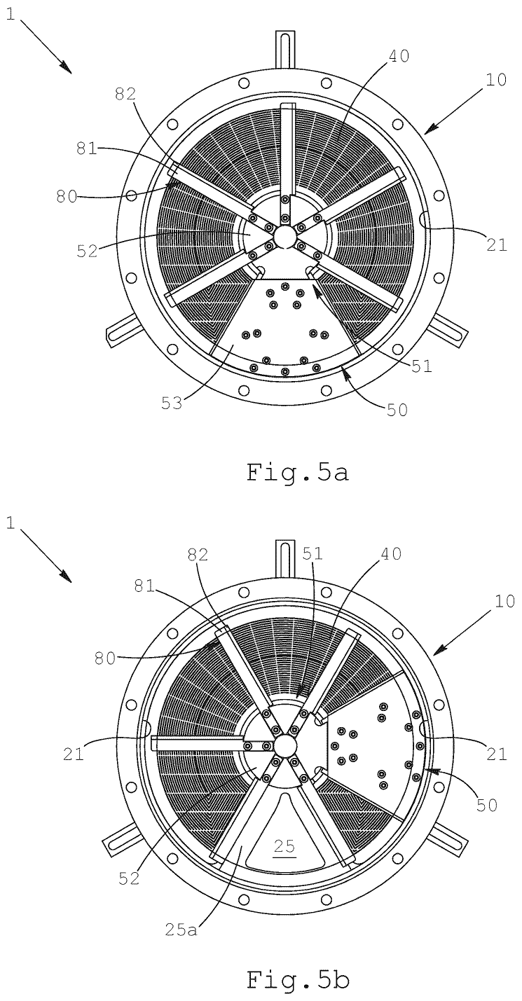

FIGS. 5a and 5b are plan views of the self-cleaning filter of FIG. 1 without the cover, respectively with the closing element in closing position and during a cleaning cycle;

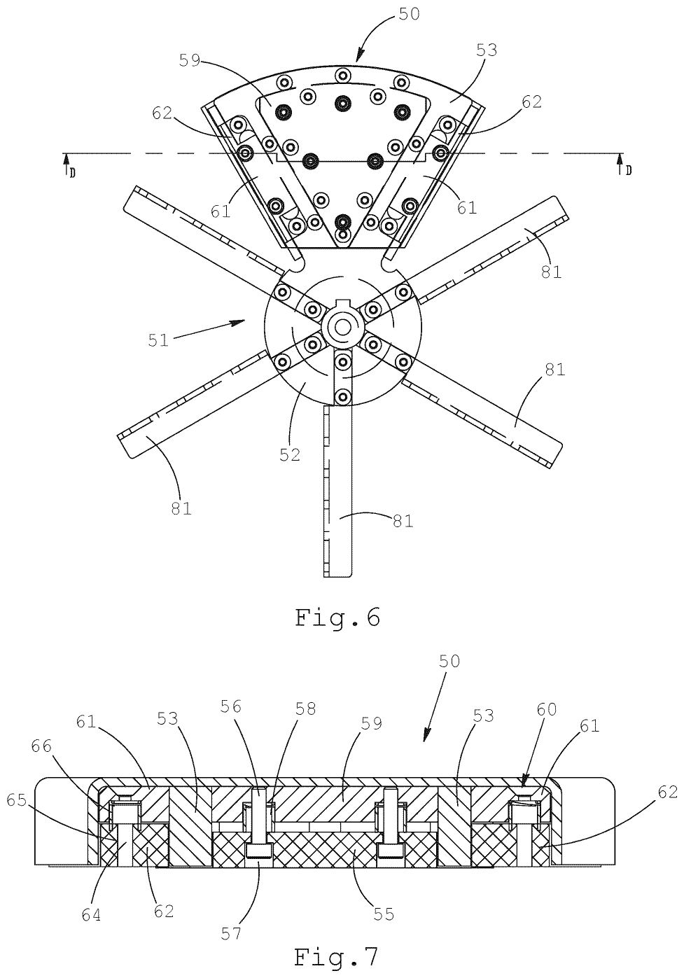

FIG. 6 is a plan view of the closing element of the self-cleaning filter according to the present invention;

FIG. 7 is a front view of the closing element of FIG. 6, sectioned along a vertical plane D-D;

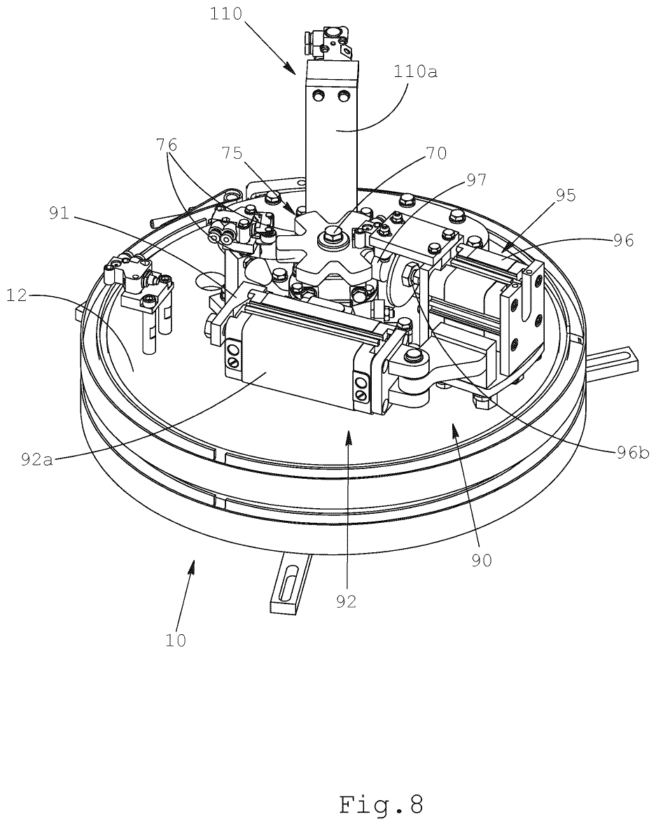

FIG. 8 represents a perspective view of a self-cleaning filter according to another embodiment of the present invention;

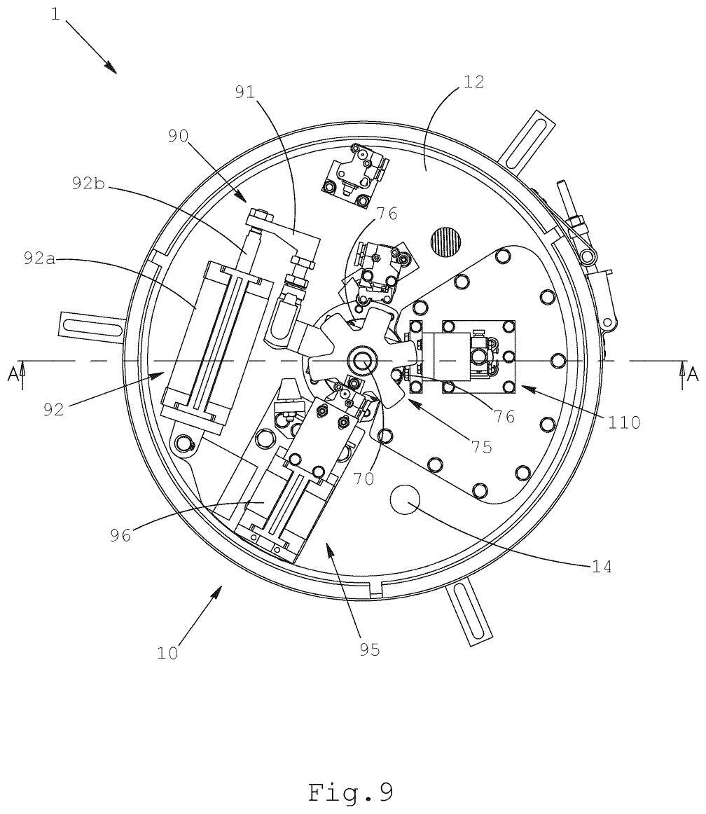

FIG. 9 is a plan view of the self-cleaning filter of FIG. 8;

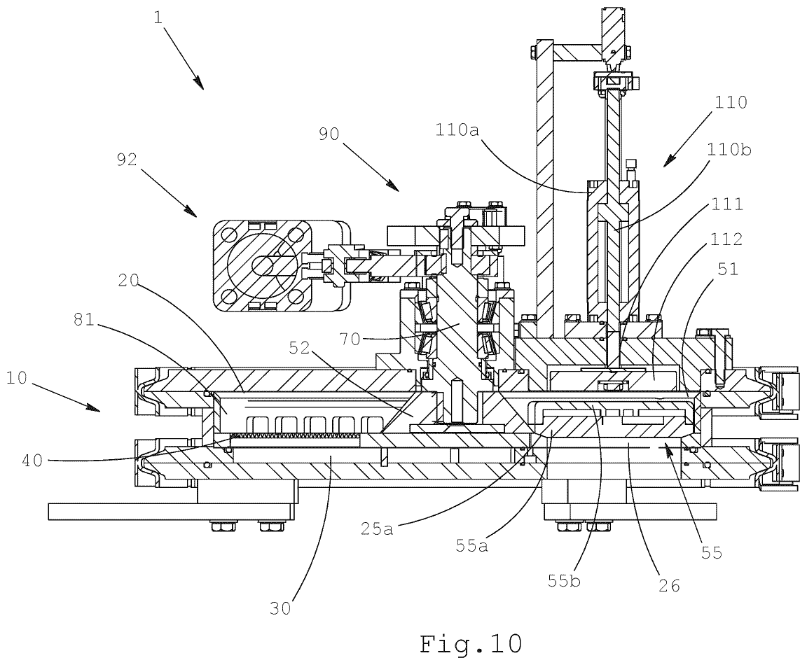

FIG. 10 is a side view of the self-cleaning filter of FIG. 8 sectioned along a vertical median plane A-A, with the filter in operating condition;

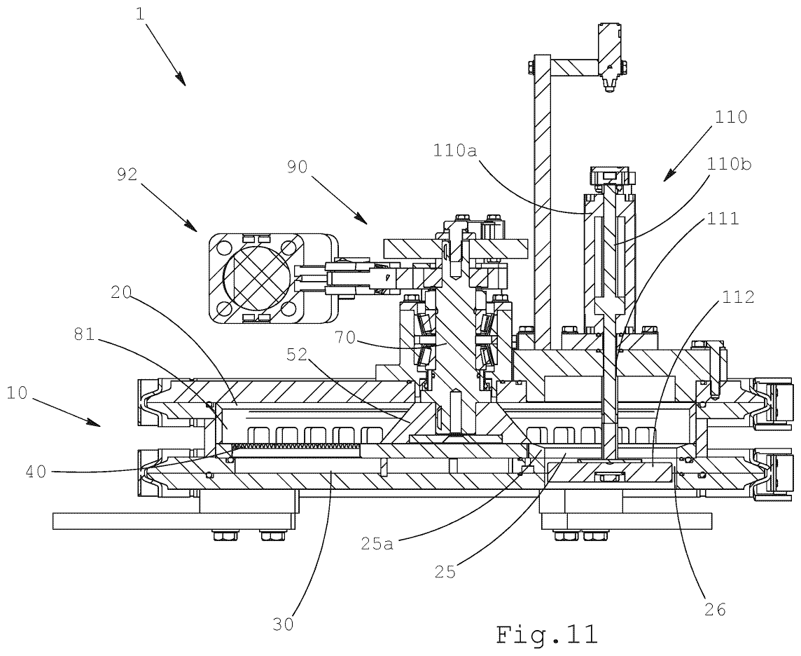

FIG. 11 is a side view of the self-cleaning filter of FIG. 8 sectioned along a vertical median plane A-A, during the cleaning cycle;

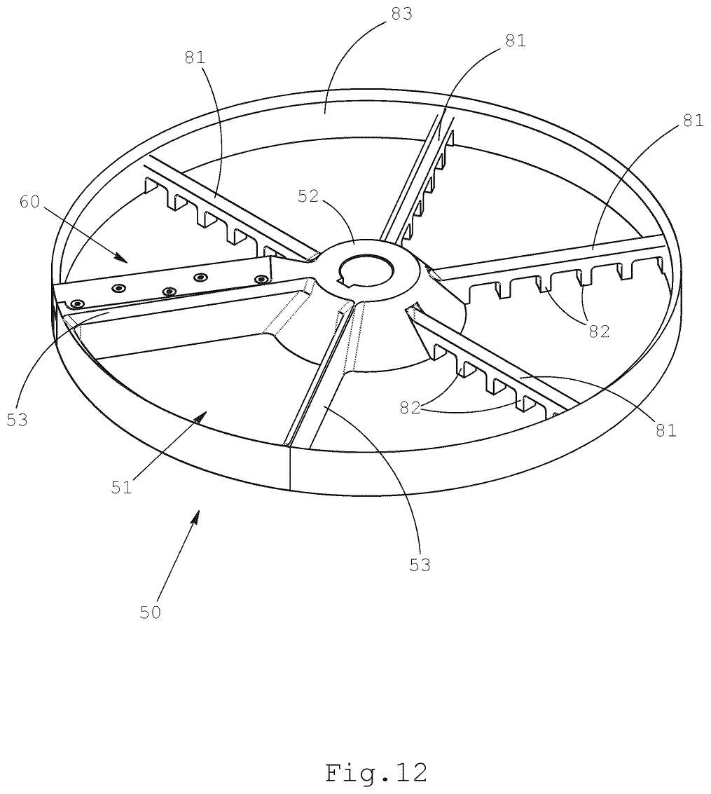

FIG. 12 is a perspective view of the support element and of the disintegration elements of the self-cleaning filter of FIG. 8.

With reference to the accompanying figures, the number 1 indicates as a whole the self-cleaning filter according to the present invention.

The filter 1 comprises a hollow body 10, substantially cylindrical and flattened, with an upper opening 11 closed by a cover 12. The cover 12 is fixed to the body by means of screws or the like.

With reference to FIGS. 3 and 4, a first chamber 20 and a second chamber 30, superimposed, are produced in the body 10. The first chamber 20 has a cylindrical side wall 21 and a base wall 22. The lower (inner) surface of the cover 12 acts as upper wall of the first chamber 20. An inlet 14 is produced in the cover 12 to allow the liquid to be filtered to be fed into the first chamber 20.

A filter medium 40 is arranged at the base wall 22 of the first chamber, separating the first chamber 20 from the second chamber 30. More in detail, said base wall 22 has a seat 23 in which said filtering element is received resting on an abutment edge 24.

According to the variant illustrated, the filter medium 40 has a circular ring sector plan shape with an angular extension ranging from 270° to 330°.

The base wall 22 of the first chamber is also provided with an opening 25 which flows into a discharge passage 26 communicating with the outside. Said opening 25 of the discharge passage 26 is delimited by an edge 25a in the shape of a circular sector and is arranged between the end of the filter medium 40 in a manner substantially complementary with respect thereto. In practice, the surface occupied by the filter medium 40 and by the opening 25 of the discharge passage 26 as a whole form a substantially complete circular ring.

The second chamber 30 preferably also has a cylindrical side wall 31 and a bottom wall 32. More precisely, the second chamber has a plan shape similar to that of the filter medium 40, i.e., to a circular ring sector. The second chamber 30 is delimitated at the top by a filter medium 40.

The outlet passage 33 of the liquid filtered by the filter medium is preferably produced on the side wall 31.

With reference to FIGS. 3, 6 and 7, the number 50 indicates as a whole a movable closing element which is housed in the first chamber 20 and is adapted to close the discharge passage 26.

According to the embodiment illustrated, the closing element 50 comprises a support element 51 with a central portion 52 and a peripheral portion 53 extending from the central portion almost to the side wall 21 of the first chamber.

The peripheral portion 53 comprises a frame with a circular ring sector (or circular sector) plan shape and a larger perimeter with respect to the perimeter of the opening 25 of the discharge passage 26.

A sealing element 55 made of polytetrafluoroethylene is mounted on the support element 51, and more precisely on the peripheral portion 53. Said sealing element 55 generally has a flat profile, i.e. with a constant thickness. According to a preferred variant, said sealing element 55 is connected to the peripheral portion 53 by means of sliding pins 56 housed in respective seats 57 produced in the sealing element. Elastic elements 58, interposed between an abutment plate 59 of the support element 51 and the sealing element, push the latter toward the base surface 22 of the first chamber 20.

A pair of scraper elements 60 are mounted on the peripheral portion 53 of the support element 51. Each scraper element comprises a connection bracket 61 that supports a scraper 62, typically made of polytetrafluoroethylene or similar polymeric materials.

Preferably, the connection bracket 61 is connected to the peripheral portion 53 by means of sliding pins 64 housed in respective seats 65 produced in the abutment plate 59. Elastic elements 66, interposed between the abutment plate 59 and the connection bracket 61, push the latter and the scraper 62 toward the base surface 22 of the first chamber 20.

The closing element 50 is connected to a gear motor assembly 71 by means of a shaft 70 that extends from the central portion 52 of the support element 51 through the cover 12.

Said gear motor rotates the closing element 50 around a vertical axis Y so as to move said closing element, and more precisely the sealing element 55, between a closing position, where said sealing element 55 obstructs the opening 25 of the discharge passage (as illustrated in FIG. 5a) and an opening position, where the sealing element 55 is rotated and moved away from the opening 25 (as illustrated in FIG. 5b).

As mentioned above, rotation of the closing element 50, and hence of the scraper elements 60, allows the latter to detach the accumulation of unwanted material that can deposit on the upper surface of the filter medium 40 and push it toward the opening 25 so that it falls by gravity into the discharge passage 26.

In practice, the scraper elements 60 have the dual function of scraping the filter medium 40 and of conveying the detached material toward the discharge passage.

According to needs, the cleaning cycle of the filter can comprise a single complete rotation of the closing element or, preferably, two or more rotations, if necessary also in opposite directions of rotation.

At the end of the cleaning cycle, the closing element is returned to the operating condition (FIG. 5a) where it obstructs the discharge passage 26.

According to the variant illustrated, the closing element 50 also carries disintegration elements 80 connected to the central portion 52 of the support element 51 and integral in rotation therewith.

Said disintegration elements 80 comprise arms 81 that extend in radial and substantially horizontal direction from the central portion 52, each of which carries a plurality of prongs 82 projecting downward and which extend almost to the base wall of the first chamber.

Following rotation of the closing element, the prongs 82, the lower end of which can penetrate the layer of unwanted material, perform a disintegration and mixing action of the material, facilitating the removal action of the scraper elements 60.

With reference to the accompanying FIGS. 8 and 9, the filter is illustrated according to another variant of the invention. In this variant, the closing element 50 is rotated by a pneumatic actuator assembly 90. In detail, said actuator assembly 90 comprises a ratchet lever 91 connected to the shaft 70 of the closing element 51. Said ratchet lever 91 comprises, for example, a free wheel fitted onto said shaft 70. The opposite end of the ratchet lever is hinged to a rod 92b of a pneumatic actuator 92, the body (cylinder) 92a of which is connected to the cover 12 in a manner rotatable about a vertical axis.

The length of the ratchet lever and the stroke of the actuator 92 are calculated so as to cause the support element 51 to rotate by a predetermined angle, for example of around 60° in the example illustrated, at each extension and retraction cycle of the rod 92b.

The actuator assembly 90 further comprises a rotation control device 95 configured to constrain the support element 51 to a rotation of a precise and constant angle at each extension and retraction cycle of the rod 92b.

Said rotation control device 95 comprises a pneumatic actuator 96, the rod 96b of which carries a slider 97 at the end.

A shaped wheel 75, which has a plurality of seats 76 adapted to receive the slider 97, is fitted onto the shaft 70 that extends from the support element 51, in the portion thereof that extends beyond the cover 12. The seats 76 and the slider 97 are shaped so as to be at least partly complementary so that, following the thrust exerted by the actuator 96, the slider 97 blocks the shaped wheel 75, and hence the support element 51, in a predetermined angular position.

As mentioned above, this configuration allows, after each complete turn of the support element 51, the closing element, and hence the sealing element 55, to be carried to the correct position with respect to the discharge passage to ensure hydraulic seal in the operating configuration of the filter.

Said seats 76 are evenly spaced angularly and their number is the same as the ratio between a complete angle (360°) and the amplitude of the rotation angle imparted to the support element 51 by the actuator 92.

In the example illustrated, the shaped wheel 75 has six seats corresponding to the same number of predefined angular positions.

In the variant of FIGS. 8 to 12, the sealing element 55 is mounted resting on the support element 51. In this variant, the sealing element 55 comprises an upper portion 55a made of stiff material, typically a plastic polymer, and an elastomeric insert 55b, coupled to the upper portion, which has a flat lower face adapted to come into contact with the edge 25a of the opening 25 that delimits the discharge passage 26.

Moreover, according to this variant, the filter comprises a pneumatic actuator 110 that acts as presser to maintain the sealing element 55 pressed against said edge 25a of the opening 25 when the filter is in operating condition.

Said actuator 110 comprises a cylinder 110a arranged vertically, the rod 110b of which is housed slidingly in a hole 111 produced in the cover 12.

The end of the rod 110b is fitted with a pad 112 which, in the operating condition of the filter, is pressed by the actuator 110 against the sealing element 55, as illustrated in FIG. 10.

Said actuator 110 and the related pad 112 can be used, during the cleaning cycle, to push the material separated from the filter medium 40 into the discharge passage. As shown in FIG. 10, the rod 110b can be extended so as to carry the pad 112 to the initial section of the discharge passage 26.

FIG. 12 illustrates the support element 51 and the arms 81 of the disintegration elements 80 according to said variant of the invention. According to this variant, a perimeter annular element 83 is integral with the ends of said arms 81.

In addition to performing a mechanical function to make the assembly of the support element 51 and of the arms 81 stiffer and stronger, said annular element 81 limits any accumulation of the material to be separated at the edge 25a of the opening 25 on the bottom of the first chamber, as this accumulation would be more difficult for the scraper 60 and/or for the pad 112 to eliminate.

Naturally, the invention is not limited to the embodiments illustrated and described above, and the person skilled in the art may make variations and modifications without departing from the scope of the invention.

1. A self-cleaning filter (1) for liquids comprising a body (10) with:
a first chamber (20) communicating with an inlet (14) for the inflow of a liquid to be filtered;
a second chamber (30) communicating with a liquid outlet (33);
wherein the two first and second chambers are substantially superimposed and communicating with each other by means of a flat filter medium (40),
wherein the first chamber (20) is also communicating with a discharge passage (26) that allows the elimination of unwanted material separated and retained by the filter medium (40),
the filter (1) further comprising a closing element (50) of the discharge passage (26), housed in the first chamber (20), and at least one scraper element (60), connected to said closing element (50),
wherein the closing element (50) is mounted rotatably in the first chamber (20) around an axis (Y) and can perform a circular trajectory that comprises a cleaning path and at least one closing position of the discharge passage (26),
and wherein said at least one scraper element (60) is in contact with the filter medium (40) during the movement of the closing element (50) in the section of the cleaning path so that, following rotation, the scraper element (60) can remove any accumulation of unwanted materials deposited on the filter medium (40) and convey it toward the discharge passage (26) through which it is eliminated from the filter.

2. The filter (1) according to claim 1, wherein the first chamber (20) has a substantially cylindrical and flattened shape and wherein the filter medium (40) and the discharge passage (26) are arranged at the base, or lower, wall (22) of said first chamber (20).

3. The filter (1) according to claim 2, wherein said filter medium (40) has a plan profile in the shape of a circular sector or circular ring sector and wherein the discharge passage (26) also has a circular sector or circular ring sector plan shape substantially complementary to that of the filter medium (40).

4. The filter (1) according to claim 1, wherein the filter medium (40) is chosen from filtering mesh, perforated metal sheets, “wedge wire screen” panels or fabrics.

5. The filter (1) according to claim 2, wherein the closing element (50) comprises a support element (51, 53), mounted on the body (10) in a manner rotatable around a substantially vertical axis (Y), and a sealing element (55), connected to the support element (51), which, in the closing position, is resting on an edge (25a) that delimits the discharge passage (26).

6. The filter (1) according to claim 5, wherein the sealing element (55) is mounted on the support element (51, 53) with slight clearance along a vertical direction and is subject to the action of elastic means (58) that press said sealing element (55) against the edge (25a) that delimits the discharge passage (26).

7. The filter (1) according to claim 5, comprising a pneumatic actuator (110) adapted to press the sealing element (55) against the edge (25a) that delimits the discharge passage (26).

8. The filter (1) according to claim 5, wherein the at least one scraper element (60) comprises a bar (62) arranged radial or slightly tangential with respect to the rotation axis (Y) of the closing element (50) and wherein said scraper element (60) is mounted on the support element (51, 53) with slight clearance in vertical direction and is subject to the action of elastic means (66) that press it against the filter medium (40) to facilitate the scraping action along the cleaning path.

9. The filter (1) according to claim 1, wherein the closing element (50) is connected to and is integral in rotation with disintegration elements (80) of the layer of unwanted material accumulated on the filter medium (40), each disintegration element (80) comprising one or more arms (81) that extend radially with respect to the rotation axis (Y), each of which carries a plurality of prongs (82) projecting downward and which extend almost to the base wall (22) of the first chamber (20).

10. The filter (1) according to claim 1, wherein the body (10) has an opening (11) at an upper wall of the first chamber (20), said opening (11) being closed by a removable cover (12).

11. The filter (1) according to claim 5, wherein the support element (51, 52) is pivoted on the cover (12) of the body, a shaft (70) to which a gear motor (71) that controls rotation of the closing element (50) is connected extending from the support element (51, 52).

12. The filter (1) according to claim 5, wherein the support element (51, 52) is pivoted on the cover (12) of the body, a shaft (70) to which a ratchet lever (91) is connected, in turn connected to a pneumatic actuator (92) that controls rotation of the closing element (50), extending from the support element (51, 52).
